(19) United States
(12) Patent Application Publication
(10) Pub. No.: US 2011/0214923 A1
(43) Pub. Date: Sep. 8, 2011

(54) LIGHT WEIGHT AND FULL PLANAR ELECTROMAGNETIC DIGITIZER

(75) Inventors: Wei-Chou Chen, Hsin-Chu (TW); Kuang-Yao Hsieh, Hsin-Chu (TW); Jen-Shuo Liu, Hsin-Chu (TW); Chia-Te Huang, Hsin-Chu (TW)

(73) Assignee: WALTOP INTERNATIONAL CORPORATION, Hsin-Chu (TW)

(21) Appl. No.: 12/903,929

(22) Filed: Oct. 13, 2010

(30) Foreign Application Priority Data
Mar. 5, 2010 (TW) 099106385

(51) Int. Cl. G06F 3/041

(52) U.S. Cl. 178/18.01

(57) ABSTRACT

A light weight and full planar electromagnetic digitizer is disclosed. The electromagnetic digitizer comprises a upper board, a lower board, a circuit board and an antenna board and a cushion board. The circuit board has at least one electronic device to control the antenna board to transmit or receive electromagnetic signals and process received electromagnetic signals. The cushion board has at least one hole or cave to accommodate the electronic device. The circuit board, the antenna board and the cushion board are stacked between the upper board and the lower board.

### FIELD OF THE INVENTION

The present invention relates to an electromagnetic digitizer, and more particularly to a light weight and full planar electromagnetic digitizer.

### DESCRIPTION OF THE PRIOR ART

A product of digitizer or digital tablet usually include a stylus or an electromagnetic pen as a pointer and a digitizer or digital tablet. An electromagnetic pen has a circuit with capacitors and inductors. A digitizer comprises signal detection and processing circuits including signal amplifiers, an analog to digital converter, a micro controller unit or a central processing unit, and a plurality of sensor coils or antennas on printed circuit boards to detect and process electromagnetic signals from the electromagnetic pen so as to transmit signals of coordinates, trace or frequency variation of the electromagnetic pen to a host and to show on a display.

Conventional digitizers or digital tablets comprise an upper case and a lower case encasing an antenna board and a printed circuit board. The upper case is usually a plastic case formed by molding, while the lower case may also be a plastic case or an iron case. The weight of the digitizer is mainly constituted by the upper and lower cases. Furthermore, the manufacture of the upper and lower cases need particular molds custom-made and the thickness of the upper and lower cases must be large enough to maintain surface flatness and for easy demolding during manufacture. These features of conventional digitizer case manufacture not only raise the production cost, but also increase the weight of the digitizer. Moreover, since the printed circuit board has various electronic components with certain heights thereon, conventional digitizer/digital tablet do not meet the requirements of light weight and full planar.

A coordinate and pressure input device is disclosed in China patent application CN200820079514.0, which includes a circuit board encased by a hard plastic case and an antenna board enclosed by soft materials. The input device is a partial flexible tablet, but not a full planar one. Taiwan patent M366709 discloses a tablet of a mouse pad comprising a main frame with a hollow space which encloses a digitizer therein and a plate covering the digitizer. Although enclosing the digitizer in the main frame achieves a full planar requirement, but does no meet the light weight requirement. Furthermore, since the total thickness of the tablet must be large enough to encase the digitizer, the thickness of the main frame would render the digitizer failure or insensitive.

In order to solve the above-mentioned drawbacks of conventional digitizers or digital tablets, the invention provides a light weight and full planar electromagnetic digitizer to meet the requirements of light weight and full planar.

### SUMMARY OF THE INVENTION

An object of the present invention is to provide a light weight and full planar electromagnetic digitizer. The electromagnetic digitizer has advantages of light weight, full planar and convenient for carrying. The electromagnetic digitizer can also be used as a mouse pad due to the features of full planar and convenient for carrying. The electromagnetic digitizer also has advantages of easy manufacture and various exterior designs.

According to the object, one embodiment of the present invention provides a light weight and full planar electromagnetic digitizer. The electromagnetic digitizer comprises an upper board, a lower board, a circuit board and an antenna board and a cushion board. The circuit board has at least one electronic device to control the antenna board to transmit or receive electromagnetic signals and process received electromagnetic signals. The cushion board has at least one hole or cave to accommodate the electronic device. The circuit board, the antenna board and the cushion board are stacked between the upper board and the lower board. The circuit board comprises a soft material, which can be compressed under pressure of attaching of the upper and lower board, so as to achieve a full planar structure.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 shows an explored view of a light weight and full planar electromagnetic digitizer of one embodiment of the invention.

FIG. 2 shows one embodiment of the lower board.

FIGS. 3A and 3B show two embodiments of the connection between the antenna board and the circuit board.

FIGS. 4A and 4B show two side views of two embodiments of the electromagnetic digitizer after combination.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

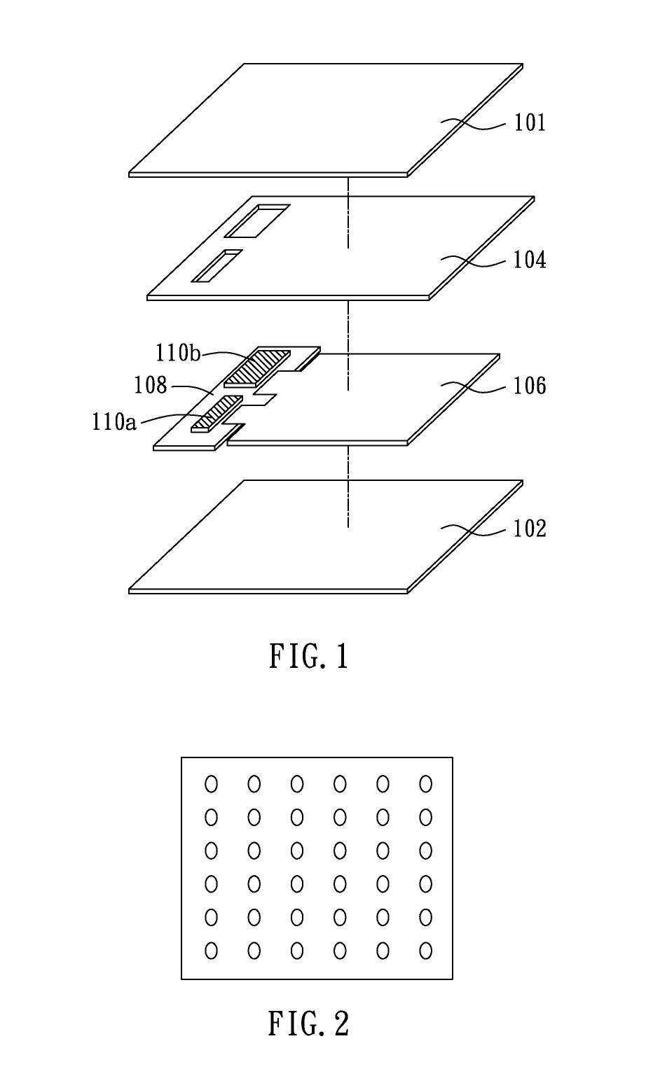

Referring to FIG. 1, an explored view of a light weight and full planar electromagnetic digitizer of one embodiment of the invention is shown. The light weight and full planar electromagnetic digitizer comprises an upper board 101, a lower board 102, a circuit board 108, an antenna board 106 and a cushion board 104. The upper board 101 and the lower board 102 comprise half cases with planar surfaces and materials of plastic, but not limited to plastic materials. The cushion board 104 comprises a soft material including, but not limited to, Polyurethane (PU) foam, rubber, and silicone etc. The cushion board 104 can be compressed under pressure of attaching of the upper board 101 and lower board 102, so as to achieve a full planar structure. The antenna board 106 comprises a plurality of partially overlapped and parallel conductive antennas or sensor coils aligned along x axis and y axis respectively and a substrate to constitute an electromagnetic sensor coil substrate. The light weight and full planar electromagnetic digitizer comprises a digitizer using a batteryless pointer or stylus and a digitizer using a self-powered pointer or stylus. The electromagnetic sensor coil substrate of the digitizer using a self-powered pointer or stylus further comprises loop coils for transmitting control signals to the pointer or stylus aligned around the antennas or sensor coils. The substrate of the antenna board 106 comprises, but not limited to, a printed circuit board. The circuit board 108 includes electronic devices 110a and 110b thereon, and a printed circuit board. The electronic devices 110a and 110b comprise a control circuit and a signal processing circuit and other necessary components. The control circuit includes, but not limited to, a micro-controller unit (MCU). The signal processing circuit includes, but not limited to, an application-specific integrated circuit (ASIC). The signal processing circuit comprises a signal amplifier, a filter, a rectifier, a phase detector, an analog to digital converter etc. The antennas or sensor coils connect to switches controlled by the control circuit to select and switch the antennas or sensor coils to transmit or receive electromagnetic signals. The cushion board 104 has at least one hole or cave corresponding to the electronic devices 110a and 110b on the circuit board 108 to accommodate the electronic devices 110a and 110b. The thickness of the cushion board 104 is preferably large enough to accommodate the electronic devices 110a and 110b. Since the circuit board 108 has the electronic devices 110a and 110b with certain heights, the direct combination of the lower board 102, the antenna board 106, the circuit board 108 and the upper board 101 would be planar. Thus the cushion board 104 is placed between the upper board 101 and the lower board 102 to achieve the feature of full planar. All components and devices in the above-mentioned embodiment are only examples instead of limitations, various modifications made without departing from the scope of the present invention are included in the scope of the present invention.

Referring to FIG. 2, one embodiment of the lower board 102 is shown. The surface of one side of the lower board 102 comprises, but not limited to, an adhesive or other attaching devices/materials to attach the cushion board 104 or the antenna board 106 or the circuit board 108. The surface of the other side of the lower board 102 could be processed to have a rough surface or less slidable surface to render the electromagnetic digitizer less slidable on a working plane such as a surface of a desk. The surface of one side of the upper board 101 comprises, but not limited to, an adhesive or other attaching devices/materials to attach the cushion board 104 or the antenna board 106 or the circuit board 108. The surface of the other side of the upper board 101 can be processed to have suitable reflection features being suitable for the use of a mouse thereon.

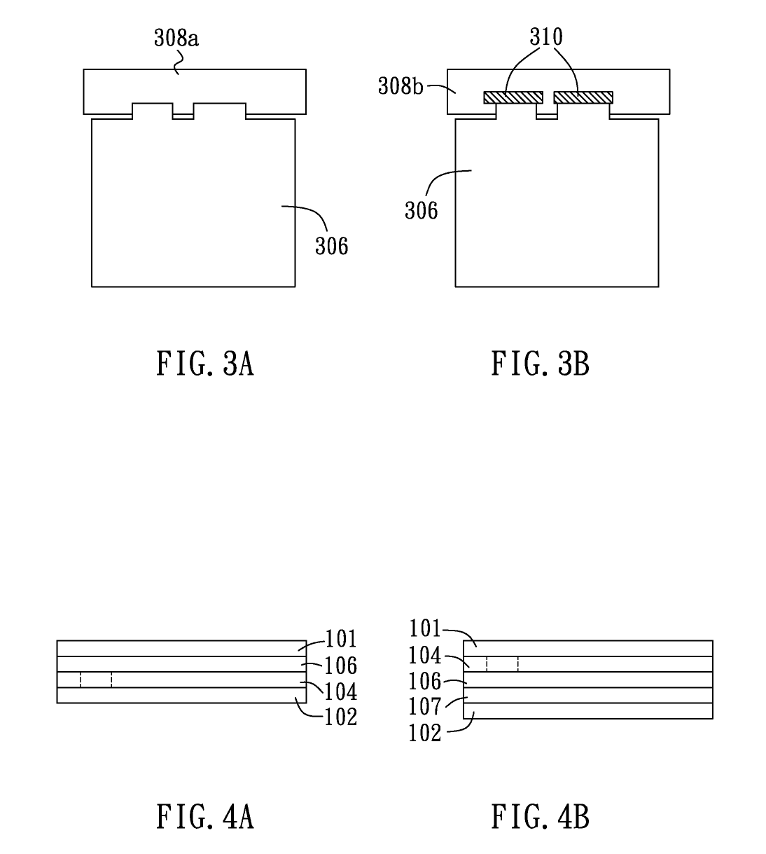

As shown in FIGS. 3A and 3B, two embodiments of the connection between the antenna board and the circuit board. As shown in FIG. 3A, the antenna board 306 and the circuit board 308a are connected by thermal compressing with an anisotropic conduction film (ACF), but not limited to be connected by thermal compressing with an ACF. As shown in FIG. 3B, the antenna board 306 and the circuit board 308a are connected by the connector 310, but not limited to be connected by the connector 310.

FIGS. 4A and 4B show two side views of two embodiments of the electromagnetic digitizer after combination. As shown in FIG. 4A, the upper board 101 attaches to the antenna board 106 and the circuit board 108 with the surface having an adhesive or other attaching devices/materials for attaching. The cushion board 104 attaches to the antenna board 106 and the circuit board 108 with the holes or caves corresponding to the electronic devices 110a and 110b on the circuit board 108 to accommodate the electronic devices 110a and 110b. In FIG. 4A, the upper board 101 attaches to the antenna board 106 and the circuit board 108, while the lower board 102 attaches to the cushion board 104 with the surface having an adhesive or other attaching devices/materials for attaching. The surface of the other side of the upper board 101 is suitable for the use of a mouse and/or a pointer or stylus thereon. The other side of the lower board 102 has a rough surface or less slidable surface to render the electromagnetic digitizer less slidable on a working plane such as a surface of a desk. The pointer or stylus comprise a self-powered pointer or stylus or a batteryless pointer or stylus with a resonant circuit. As shown in FIG. 4B, the upper board 101 attaches to the cushion board 104 with the surface having an adhesive or other attaching devices/materials for attaching. The cushion board 104 attaches to the antenna board 106 and the circuit board 108 with the holes or caves corresponding to the electronic devices 110a and 110b on the circuit board 108 to accommodate the electronic devices 110a and 110b. Unlike to the embodiment shown in FIG. 4A, in FIG. 4B, the upper board 101 attaches to the cushion board 104, the lower board 102 attaches to a silicon steel slice 107 with the surface having an adhesive or other attaching devices/materials for attaching, and the silicon steel slice 107 attaches to the antenna board 106 and the circuit board 108. The surface of the other side of the upper board 101 is suitable for the use of a mouse and/or a pointer or stylus thereon, while the other side of the lower board 102 has a rough surface or less slidable surface to render the electromagnetic digitizer less slidable on a working plane. The silicon steel slice 107 can be omitted and the attaches to the antenna board 106 and the circuit board 108 with the surface having an adhesive or other attaching devices/materials for attaching.

Although specific embodiments have been illustrated and described, it will be appreciated by those skilled in the art that various modifications may be made without departing from the scope of the present invention, which is intended to be limited solely by the appended claims.

What is claimed is:

1. An electromagnetic digitizer, said electromagnetic digitizer comprising:
an upper board;
a circuit board and an antenna board, the circuit board having at least one electronic device controlling the antenna board to transmit or receive electromagnetic signals, and processing the electromagnetic signals received by the antenna board;
a cushion board, the cushion board having at least one hole to accommodate the electronic device; and
a lower board, wherein the circuit board, the antenna board and the cushion board are between the upper board and the lower board.

2. The electromagnetic digitizer according to claim 1, wherein the upper board and the lower board comprise half cases with planar surfaces and materials of plastic.

3. The electromagnetic digitizer according to claim 1, wherein the cushion board comprises a soft material.

4. The electromagnetic digitizer according to claim 3, wherein the soft material is selected from one of polyurethane foam, rubber or silicone.

5. The electromagnetic digitizer according to claim 1, wherein the surface of one side of the upper board comprises an adhesive, and the surface of the other side of the upper board is processed to have suitable reflection features being suitable for the use of a mouse thereon.

6. The electromagnetic digitizer according to claim 1, wherein the surface of one side of the lower board comprises an adhesive, and the surface of the other side of the lower board is processed to have a rough surface or less slidable surface to render the electromagnetic digitizer less slidable on a working plane.

7. The electromagnetic digitizer according to claim 1, wherein the antenna board and the circuit board are connected by thermal compressing with an anisotropic conduction film.

8. The electromagnetic digitizer according to claim 1, wherein the antenna board and the circuit board are connected by a connector.

9. The electromagnetic digitizer according to claim 1, further comprising a silicon steel slice between the upper board and the lower board.

10. The electromagnetic digitizer according to claim 1, wherein the upper board attaches to the antenna board and the circuit board, and the lower board attaches to the cushion board.

11. The electromagnetic digitizer according to claim 1, wherein the upper board attaches to the cushion board, and the lower board attaches to the antenna board and the circuit board.
